(19) United States
(12) Patent Application Publication
(10) Pub. No.: US 2005/0017796 A1
(43) Pub. Date: Jan. 27, 2005

(54) Input protection circuit

(75) Inventor: Yukihiko Tanizawa, Kariya-city (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/891,005

(22) Filed: Jul. 15, 2004

(30) Foreign Application Priority Data
Jul. 22, 2003 (JP) 2003-277579

(51) Int. Cl. G06G 7/26

(52) U.S. Cl. 327/562

(57) ABSTRACT

An input protection circuit installed within a non-inverted amplifier includes a first diode with one end electrically connected to the non-inverted input terminal of the non-inverted amplifier and the other end electrically connected to the base voltage and a second diode having a cathode electrically connected to a power voltage of the non-inverted amplifier and an anode connected to the base voltage.

### CROSS REFERENCE TO RELATED APPLICATION

This application is based upon, claims the benefit of priority of, and incorporates by reference the contents of, Japanese Patent Application No. 2003-277579 filed on Jul. 22, 2003.

### FIELD OF THE INVENTION

This invention relates to an input protection circuit to prevent a non-inverted amplifier from external surge voltage.

### BACKGROUND OF THE INVENTION

Conventionally, an operational amplifier is used as an amplifier to amplify a signal from a signal source that has a large internal impedance such as, for example, a thermopile or a semiconductor pressure sensor. A non-inverted amplifier has a large input impedance, and a leakage current from the signal source to the non-inverted amplifier is almost equal to zero. Thus, the signal level of the signal source is preserved and applied to the non-inverted input terminal in almost its original value. Therefore, this type of non-inverted amplifier is suitable for amplifying a signal from a signal source with a large internal impedance.

A MOS input operational amplifier that incorporates MOS transistors as pair transistors for differential input in the input stage has higher input impedance and lower bias current compared to a bi-polar input operational amplifier, and is therefore frequently used for the amplifier for the signal source with large internal impedance.

A non-inverted amplifier circuit as a whole, including the operational amplifier, is usually formed as a portion of an IC. When an excessive voltage such as an ESD (Electro Static Discharge) is applied to the external terminals of the IC, the internal element of the IC is susceptible and may be broken.

Thus, a known protection method for protecting the operational amplifier from the excessive voltage is used. For example, an operational amplifier having two diodes disposed between the inverted input terminal and the power source and between the non-inverted input terminal and the power source respectively (cathode is on the power supply side), and also having another two diodes disposed between the inverted input terminal and the ground voltage (noted as hereinafter) and between the non-inverted terminal and the ground (anode is on the ground side), may be used to prevent the breakage of the internal element by absorbing the excessive voltage from outside. Such an operation amplifier is disclosed in Patent No. JP-A-2002-141421 (hereafter referred to as patent document No.1), the contents of which are incorporated herein by reference.

The method of the above patent document No. 1 is embodied within an exemplary input protection circuit of a non-inverted amplifier shown in FIG. 4. FIG. 4 is a schematic circuit of the output amplifier 100 that amplifies the signal (voltage signal corresponding to the temperature) from the thermopile 11. The thermopile 11 is a known detached thermal sensor element using a thermocouple. The thermopile's impedance is about 300 kω and the sensor signal (electromotive force) Vs is about 3 mV in full scale. Further description is within Patent No. JP-A-2002-202195 (hereafter referred to as patent document No. 2), the contents of which are incorporated herein by reference.

The output amplifier 100 is composed of the operational amplifier OP, a known non-inverted amplifier comprising resistors R1 and R2, and an input protection circuit 110 that protects the operational amplifier from external excessive current such as ESD. The output amplifier 100 is preferably incorporated in an IC. The sensor signal Vs from the thermopile 11 is input to the non-inverted input terminal of the operational amplifier OP through a signal input terminal (+) 121, and is amplified to a predetermined degree to be output for external use.

The operational amplifier OP is preferably a MOS input operational amplifier and has a MOS transistor T1 on its non-inverted input side and another MOS transistor T2 on its inverted input side. The voltage at one end of the resistor R2 (on the other side of the inverted input terminal side), which is same voltage of the signal input terminal (−) 122 and a base voltage of the sensor signal Vs, is raised by a predetermined voltage Vref. This is done because a small voltage such as the few mV above GND level in this case that is input into the operational amplifier in order to amplify a signal is not sufficient for the usual operational amplifier with single power operation and non-rail-to-rail I/O, as in the above example where the sensor signal Vs of the thermopile 11 is as small as a couple of mV. Raising the base voltage of the sensor signal from GND by Vref ensures the amplification of the signal.

The input protection circuit is comprised of a diode D11 (anode is on the non-inverted input terminal side) connected between the non-inverted input terminal and the power source voltage Vcc, a diode D13 (anode is on the base voltage side) connected between the base voltage and the power source voltage Vcc, a diode D12 (anode is on the GND side) connected between the non-inverted input terminal of the operational amplifier and GND, and a diode D14 (anode is on the GND side). Each diode D11-D14 is made by short-circuiting between the gate and the source of a MOS transistor.

The output amplifier 100, according to the structure stated above, is protected from an excessive voltage by the current induced by the diode D11 in the forward/reversed direction (by utilizing an yield phenomenon) when an excessive voltage such as an ESD is applied between the signal input terminal (+) 121 and the power source voltage Vcc. Also, as an example, the operational amplifier OP is protected from an excessive voltage by the current induced by the diode D12 in the forward/reversed direction (by utilizing an yield phenomenon) when an excessive voltage is applied between the signal input terminal (+) 121 and the ground voltage GND.

Similar effects are achieved when an excessive voltage is applied between the signal input terminal (−) 122 and the power source voltage Vcc terminal, or, a GND, and thus the operational amplifier is protected from an excessive voltage by a forward/reversed current (utilizing an yield phenomenon) through the diode D13, D14.

However, although the input protection circuit 110 protects the non-inverted amplifier from an excessive voltage, a leakage current from diodes D11 and D12 causes another leakage current from the thermopile 11 to the output amplifier 100, which results in both a large voltage drop by the internal impedance Rs inside the thermopile and a temperature measurement error.

Namely, the voltage difference between the power source voltage Vcc and the signal input terminal (+) 121, and, the difference between signal input terminal (+) 121 and the GND, are both large enough to cause a leakage current in the direction indicated by an arrow shown in FIG. 4. Therefore, this leakage current results in a voltage drop by the internal impedance Rs in the thermopile 11. Sensor signal Vs is then decreased by the voltage drop before being input to the signal input terminal (+) 121 (that leads finally to the non-inverted input terminal of the operational amplifier) The problem stated above is exceedingly notable in the case where the signal from a signal source with a large internal impedance is amplified.

In other words, the advantages of high input impedance and almost zero bias current achieved by use of the non-inverted amplifier composed of a MOS input operational amplifier diminish when the input protection circuit 110 drains a leakage current. That is, the input protection circuit 110 causes a decrease of input impedance of the output amplifier 100 as a whole.

In view of the above problems in the conventional art, the present invention has as an object to provide an input protection circuit that can protect a non-inverted amplifier from an excessive external voltage while suppressing a leakage current from the external signal source.

### SUMMARY OF THE INVENTION

Accordingly, the present invention provides an input protection circuit that is installed in a non-inverted amplifier. The input protection circuit is comprised of an operational amplifier with its input being received by a non-inverted input terminal, a first resistor disposed between the output terminal and the inverted input terminal of the operational amplifier, and a second resistor connected to the inverted input terminal of the operational amplifier at one end and to the base voltage of the input signal at the other end. The base voltage of the input signal is raised to a predetermined level that is higher than a ground level voltage.

The input protection circuit is further comprised of a first diode with one end connected to the non-inverted input terminal and the other end connected to the base voltage, and a second diode with its cathode connected to the power voltage of the non-inverted amplifier and its anode connected to the base voltage.

A non-inverted amplifier equipped with the input protection circuit according to the above structure is protected from an excessive voltage applied, for example, between the non-inverted input terminal and the base voltage (that is, the second resistor) because a current from the excess voltage is directed to the first diode (either in the forward/reverse direction). Also, when an excessive voltage is applied between the non-inverted input terminal and the power voltage (the cathode side of the second diode), a current from the excess voltage is directed to the first diode and the second diode, and thus the circuit can be protected from the excessive voltage in the same way. Furthermore, when an excessive voltage is applied between the base voltage and the power voltage, a current from the excess voltage can be released through the second diode and the protection is provided in the same way.

The voltage applied on both ends of the first diode that composes the input protection circuit is equal to the input voltage of the non-inverted amplifier (that is, a signal voltage of the input signal). The input voltage is generally a very small voltage that only yields a very low current in the first diode, although it depends on the gain of the input voltage of the non-inverted amplifier and the like.

As a result, by using the above input protection circuit, there is limited if any leakage current from the external signal source to the first diode, and it is possible to protect the non-inverted amplifier from the external excessive current while suppressing the leakage current from the external signal source.

An input protection circuit may further include a third diode with its cathode connected to the base voltage and its anode connected to the ground voltage.

The input protection circuit according to the above structure can protect the non-inverted amplifier from an excessive voltage when it is applied between the non-inverted input terminal and the ground voltage, because the (excessive) current can be released through the first and the third diodes. Also, if the excessive voltage is, for example, applied between the base voltage and the ground voltage, the third diode can release the current and an internal circuit such as the non-inverted amplifier can be protected. That is, protection for the excessive voltage based on the base voltage can also be provided.

Furthermore, it is possible to compose a circuit so that the signal voltage is applied between the first and the second protection resistor while the other end of the first protection resistor is connected to the non-inverted input terminal and the other end of the second protection resistor is connected to the base voltage.

According to this method, the current induced by the excessive voltage that flows into the diode from the same side as the signal voltage application (that is, from the other side of the above protection resistor) is also directed to any one of the protection resistors, and thus excessive voltage energy can be dispersed among the protection resistors to lessen the load of each diode.

The operational amplifier that composes the non-inverted amplifier may be implemented by a MOS input operational amplifier, whose two transistors used in the differential input circuit in the input stage for receiving the non-inverted input and the inverted input respectively are MOS transistors. The operational amplifier may also be implemented by a bi-polar transistor. A MOS input operational amplifier is, as described in the prior art section, high in input impedance and nearly equal to zero in input bias current, and is therefore suitable for an operational amplifier in a non-inverted amplifier amplifying the signal from the external signal source with high internal impedance. Also, the MOS structure generally has a very thin oxide film, and dielectric breakdown in the gate oxide film might be caused when an excessive voltage is applied.

Therefore, the input protection circuit can be utilized effectively as the input protection circuit to protect non-inverted amplifier, especially when the operational amplifier is implemented by a MOS input type, from the excessive voltage, because the characteristics of the input bias being nearly equal zero can be maximized and the MOS input operational amplifier which is more vulnerable to the dielectric breakdown can securely be protected from the excessive voltage.

### BRIEF DESCRIPTION OF THE DRAWINGS

The above and other objects, features and advantages of the present invention will become more apparent from the following detailed description made with reference to the drawings. In the drawings;

FIG. 1 shows a circuit diagram of an output amplifier according to a preferred embodiment;

FIG. 2 shows a circuit diagram of a the output amplifier according to a first modification;

FIG. 3 shows a circuit diagram of a the output amplifier according to a second modification; and

FIG. 4 shows a circuit diagram of an output amplifier according to a prior art.

### DESCRIPTION OF THE PREFERRED EMBODIMENTS

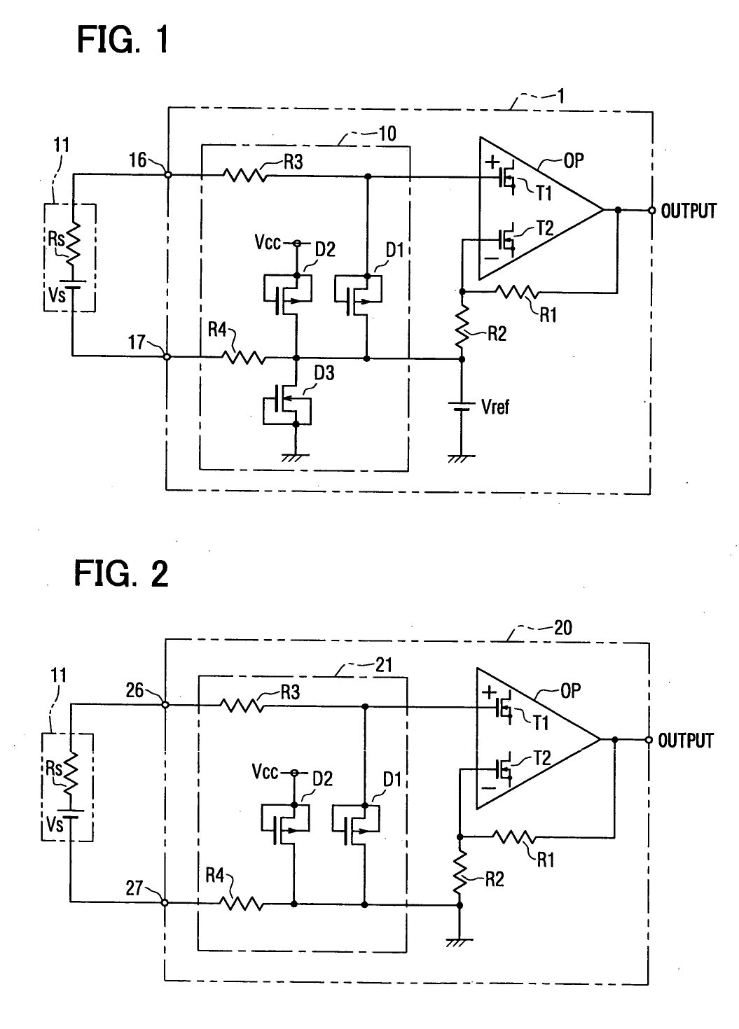

First, as shown in FIGS. 1-4, a schematic diagram of an input protection circuit is comprised of output amplifiers 1, 20, 30, 100, input protection circuits 10, 21, 31, 110, a thermopile 11, signal input terminals (+) 16, 26, 36, signal input terminals (−) 17, 27, 37, diodes D1, D2, D3, D4, an operational amplifier OP, resistors R1, R2, protection resistors R3, R4, and MOS type transistors T1, T2.

The preferred embodiment of the present invention is described based on the drawings. FIG. 1 shows a circuit diagram of an output amplifier according to a preferred embodiment. The output amplifier 1 is for amplifying the input received from a thermopile 11 (sensor signal Vs) and sending an output to an external circuit (not shown) after amplification, in a manner similar to the conventional output amplifier 100 in FIG. 4. The operational amplifier OP, a non-inverted amplifier comprised of a resistor R1 and R2, and an input protection circuit 10 are all preferably incorporated in one IC as the output amplifier.

A sensor signal Vs is inputted into the non-inverted input terminal of the operational amplifier OP from a signal input terminal (+) 16 through the protection resistor R3 and is then amplified to a predetermined level to be sent out to the external circuit.

The non-inverted amplifier is similar to the one used in the output amplifier 100 shown in FIG. 4, and one of the terminals of the resistor R2 (on the other side of the inverted input terminal) is raised to the Vref level based on the ground (GND) level, as in FIG. 4. Further, the thermopile is also the same as in FIG. 4. Thus, the same numerals are assigned to the same element as in FIG. 4, and a detail explanation is omitted.

The input protection circuit 10 includes a diode D1 with its cathode connected to the non-inverted input terminal and its anode connected to the resistor R2 on its other end. The voltage level is raised to Vref (hereafter “base voltage Vref”) and base voltage of the sensor signal. The input protection circuit 10 also includes a diode D2 with its cathode connected to power voltage Vcc (provided from a power source of the non-inverted amplifier not shown FIGS.) and its anode connected to the base voltage Vref, a diode D3 with its cathode connected to the base voltage Vref and its anode connected to GND, a protection resistor R3 with one end connected to the signal input terminal (+) 16 and the other end connected to the non-inverted input terminal, and a protection resistor R4 with one end connected to the signal input terminal (−) 17 and the other end connected to the base voltage Vref.

Diodes D1-D3 are all MOS type transistors having their gate-source connected (short-circuited) to be used as diodes.

According to the structure as described above, the operational amplifier is protected from an excess voltage applied between the signal input terminal (+) 16 and: the power voltage Vcc terminal; the GND; or/and the signal input terminal (−) 17. More particularly, when an excess voltage is applied, for example, between the signal input terminal (+) 16 and the power voltage Vcc terminal (not shown in FIGS.), a current from the excess voltage is released through the protection resistor R3, the diode D1, and the diode D2. When an excess voltage is applied between the signal input terminal (+) 16 and the GND (not shown in FIGS.), a current from the excess voltage is released through the protection resistor R3, diode D1, and diode D3. Furthermore, when an excess voltage is applied between the signal input terminal (+) 16 and the signal input terminal (−) 17, a current from the excess voltage is released through the protection resistor R3, diode D1, and the protection resistor R4, and thus the operational amplifier is protected from the excess voltage.

The operational amplifier is also protected from the excess voltage when the excess voltage is applied between the signal input terminal (−) 17 and: the power voltage Vcc terminal; and/or GND. More particularly, when an excess voltage is applied, for example, between the signal input terminal (−) 17 and the power voltage Vcc terminal, a current from the excess voltage is released through the protection resistor R4 and diode D2. Also, when an excess voltage is applied between the signal input terminal (−) 17 and GND, a current from the excess voltage is released through the protection resistor R4 and diode D3.

In this embodiment, the protection diode D1 of the input protection circuit 10 on the non-inverted input terminal is not disposed between the non-inverted input terminal and GND as shown in FIG. 4, but in between the non-inverted input terminal and the base voltage Vref.

The voltage between the both ends of the diode D1 can be calculated by the following formula:
(output voltage of the operational amplifier OP)/(gain of the non-inverted amplifier)

When the output voltage amplitude is 2 volts and the gain of the non-inverted amplifier is 100, the voltage between both ends of the diode D1 is about 20 mV. Conversely, when the gain of the amplifier is 100, a thermopile 11 with an output of about 20 mV can be used. This value, around 20 mV, is nominal compared to the voltage applied to the diode D12 in the conventional method shown in FIG. 4 (approximately a hundredth), and will not yield a reverse current in the diode D1.

Therefore, the leakage current from the thermopile 11 to the output amplifier 1 can be incommensurably minimized compared to the one in FIG. 4 and not cause any substantial problems. That is, the sensor signal Vs can be inputted, almost as it is, to the non-inverted input terminal of the operational amplifier OP without being decreased due to the internal impedance Rs and the protection resistor R3 in the input protection circuit 10.

Therefore, in this embodiment, it is possible to protect the non-inverted amplifier from the external excessive current while suppressing the leakage current from the thermopile 11 to be nearly equal to zero, because the leakage current barely flows through the diode D1 that is connected to the non-inverted input terminal. When an excess voltage is applied to the signal input terminal (+) 16 or to the signal input terminal (−) 17, a current from the excess voltage can be released through the protection resistor R3 and/or R4 among other parts, and thus the excess voltage energy can be tolerated by the two resistors resulting in a decreased load to the diodes D1, D2, and D3.

Also in this embodiment, the input protection circuit 10 used for providing the excess voltage protection of the non-inverted amplifier is preferably constructed by a MOS input operational amplifier. As a result, the operational amplifier can be protected while preserving the advantage of the input bias current being equal to nearly zero. Further, the protection against the excess voltage is securely provided to the MOS input operational amplifier, which is more susceptible to the dielectric breakdown.

The diode D1 in this embodiment corresponds to a first diode, the diode D2 corresponds to a second diode, and the diode D3 corresponds to a third diode. The resistor R1 corresponds to a first resistor, the resistor R2 corresponds to a second resistor, the resistor R3 corresponds to a first protection resistor, and the resistor R4 corresponds to a second resistor, and the constant voltage Vref corresponds to a predetermined high voltage.

As described above, a MOS type transistor with its gate and source short-circuited are used to implement the diodes D1, D2, and D3 in the above embodiment. However, a general diode with p-n junction can also be used. More broadly, any component that functions as a diode can substitute for the above mentioned MOS type transistor.

Also, in the above embodiment, a MOS input operational amplifier is described as an example of an operational amplifier OP to be used in a non-inverted amplifier. However, a bi-polar input operational amplifier can also be used for the non-inverted amplifier.

Further, in the above embodiment, the case where the base voltage of the sensor signal Vs is raised to Vref from the GND is described. However, the present invention is also applicable to, for example, a non-inverted amplifier in which its base voltage stays at GND (FIG. 2).

That is, the output amplifier 20 shown in FIG. 2 has GND as the base voltage of the sensor signal Vs, and the input protection circuit 21 that protects the non-inverted amplifier from an excessive voltage is the same as the input protection circuit 10 in FIG. 1 except for the diode D3 being deleted. The input protection circuit 21 composed in this manner can provide protection for the non-inverted amplifier from an external excessive voltage while suppressing the leakage current from the thermopile 11 to the output amplifier 20 to nearly zero.

Further, in the above embodiment, the sensor signal Vs is considered to be about 20 mV, for example. However, this voltage value is small enough compared to the forward bias (voltage) of the diode D1 (usually around 0.6 to 0.7 V) so that the diode D1 can be connected to the circuit in the same direction as the sensor signal Vs voltage without problem (forward current is small enough). That is, when the voltage of the sensor signal Vs is small enough in terms of the knee voltage of diode D1, diode D1 can be placed in the circuit without regard to its orientation (as opposed to the case in FIG. 1 where the anode is connected to the non-inverted input terminal and the cathode is connected to the base voltage Vref).

However, when the sensor signal Vs is relatively large and the signal is amplified by the non-inverted amplifier with its gain being low, the forward current cannot be ignored, and thus the diode D1 has to be connected as shown in the above embodiment (FIG. 1).

Also, there may be a situation where an output cycle from the output amplifier is reversed in order to be directed to a post stage amplifier (not shown in FIGS.). When the polarity of the sensor signal from the output amplifier 1 in FIG. 1 is reversed in relation to the above situation, the polarity of the diode D1 may well be reversed.

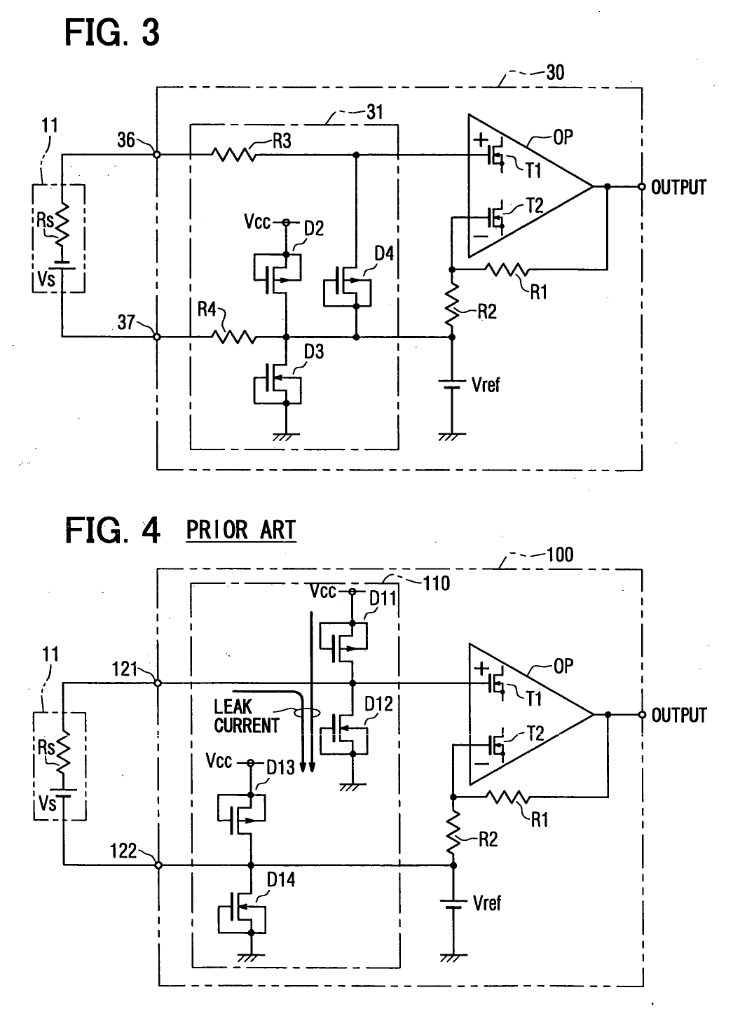

Referring to FIG. 3, an example of the above description will be discussed. When the polarity of the sensor signal Vs from the thermopile 11 is reversed as opposed to the FIG. 1 condition, the voltage signal lower than the base voltage Vref is used as an input to the non-inverted input terminal of the operational amplifier OP. Then, instead of the diode D1 in FIG. 1, the diode D4 with its anode connected to the non-inverted input terminal and its cathode connected to the base voltage Vref is used. Namely, this diode D4 has a reversed polarity of the diode D1 in FIG. 1. Even in this condition, the result is the same as the above embodiment.

Also in this case, as stated above, when the thermopile 11 that is high in non-inverted amplifier gain and low in output level is used, polarity of the diode D4 can be reversed and the sensor signal Vs can be applied forwardly with the polarity of the diode D4. Even in this arrangement, as the sensor signal Vs is minimal, the diode D4 hardly permits passage of a forward current.

On the other hand, when the thermopile 11 that is low in non-inverted amplifier gain and high in output level is used, the diode D4 is preferably used in the way described in FIG. 3. This is because the voltage that triggers the forward current in a diode (usually 0.6-0.7 V) is generally smaller than the breakdown voltage in the reverse direction.

While the present invention has been shown and described with reference to the foregoing preferred embodiments, it will be apparent to those skilled in the art that changes in form and detail may be made therein without departing from the scope of the invention as defined in the appended claims.

1. An input protection circuit installed within a non-inverted amplifier comprised of an operational amplifier that has an input signal on a non-inverted input terminal, a first resistor electrically connected between an output terminal and an inverted terminal of the operational amplifier, and a second resistor with one terminal electrically connected to the inverted terminal of the operational amplifier and the other terminal electrically connected to a base voltage of the input signal, wherein the input signal is raised to a predetermined high voltage higher than the ground level, wherein the input protection circuit comprises:
a first diode with one end electrically connected to the non-inverted input terminal of the non-inverted amplifier and the other end electrically connected to the base voltage; and
a second diode having a cathode electrically connected to a power voltage of the non-inverted amplifier and an anode connected to the base voltage.

2. An input protection circuit according to claim 1, further comprising a third diode having a cathode connected to the base voltage and an anode electrically connected to the ground voltage.

3. An input protection circuit according to claim 1, further comprising:
a first protection resistor with one end electrically connected to the non-inverted input terminal; and
a second protection resistor with one end electrically connected to the base voltage, wherein a signal voltage of the input signal is applied electrically between the other ends of the first and second protection resistors.

4. An input protection circuit according to claim 1, wherein the operational amplifier is a MOS input operational amplifier comprised of first and second transistors to form a differential input circuit in an input stage, wherein the first and second transistors respectively receive non-inverted input and inverted input.

5. A non-inverted amplifier comprising:
an operational amplifier that has an input signal on a non-inverted input terminal;
a first resistor electrically connected between an output terminal and an inverted terminal of the operational amplifier;
a second resistor with one terminal electrically connected to the inverted terminal of the operational amplifier and the other terminal electrically connected to a base voltage of the input signal, wherein the input signal is raised to a predetermined high voltage higher than the ground level; and
an input protection circuit comprised of a first diode with one end electrically connected to the non-inverted input terminal of the non-inverted amplifier and the other end electrically connected to the base voltage; and a second diode having a cathode electrically connected to a power voltage of the non-inverted amplifier and an anode connected to the base voltage.
